(19) United States
(12) Patent Application Publication
(10) Pub. No.: US 2003/0164102 A1
(43) Pub. Date: Sep. 4, 2003

(54) Method for regulation of a web tension in a rotary print machine

(76) Inventor: Johannes Georg Schaede, Wurzburg (DE)

Correspondence Address: Douglas R Hanscom, Jones Tullar & Cooper, P O Box 2266, Eads Station, Arlington, VA, 22202, US

(21) Appl. No.: 10/296,247

(22) PCT Filed: Jul. 19, 2001
(86) PCT No.: PCT/DE01/02718

(51) Int. Cl. B41F 13/02

(52) U.S. Cl. 101/225; 101/181; 101/484

(57) ABSTRACT

The invention relates to a method for the regulation of a web tension in a rotary print machine, whereby the web (B) passes through at least two printing groups (06, 07, 08, 09). A change in the extension of the web during the run, is determined by means of a change in a phase shift between a first phase position of a printing group and a second phase position measured behind a last printing group. The change in phase position is compensated by means of a change in the tension (S) of the web before the first printing group.

The invention relates to a method for regulating a web tension in a rotary printing press in accordance with the preamble of claim 1 or 3.

A register-maintaining drive mechanism for a rotary printing press is known from EP 0 951 993 A1, wherein a longitudinal elongation of the web to be imprinted is determined from web tension and operating values of the drive mechanisms, and is compensated by adjusting the circumferential register at the cylinders, or the register rollers. A change in transverse elongation detected by means of a sensor for detecting the web width is fed back via a correcting value to the reference variable of the traction roller, which is regulated to web tension constancy.

A method for regulating the drive mechanisms of a printing press aimed toward a constant elongation, is disclosed in U.S. Pat. No. 3,025,791. Here, the measurement of the elongation takes place close to the first print unit by comparing the angular position of the print unit, and thereafter the position of a marker on the material to be imprinted. A change in the relative position causes a change in the tension of the web of material to be imprinted in the draw-in unit.

DE 92 16 978 U1 discloses a first regulating circuit, where a tension between a print unit and a traction roller is regulated to be constant. In a second regulating circuit the angular position of the cutting cylinder is regulated via the drive mechanism of the cutting cylinder on the basis of a rotary position of the print unit and the cutting cylinder, as well as an optical signal which processes the position of a marker.

The object of the invention is based on providing methods for regulating a web tension in a rotary printing press.

In accordance with the invention, this object is attained by means of the characteristics of claim 1 or 3.

The advantages which can be achieved by means of the invention rest in particular in that fluctuations or changes in the elongation during a production run, i.e. during continuous printing, can be measured in a simple way, and that this measurement is used for regulating the draw-in unit located upstream of the first print unit.

Measurement downstream of the last print unit in particular provides the most information regarding the operational state of the web prior to running into the superstructure, in particular the hopper inlet.

The tension/elongation behavior of the web when the web passes through the imprinting position changes with the addition of water and/or ink and causes, for example, an increase in the elongation after the last print unit. However, so that during multiple web operations a problem-free insertion of the webs into the hopper is assured, the suitable web tension level of the webs in respect to each other for achieving the necessary gradation in the web tension after water and ink have been added is matched, if possible, only by means of adjusting the draw-in unit.

The paper web expands under the effects of the damping agent and/or the ink both in the longitudinal and transverse directions in relation to the conveying direction. This has the effect of elongating the web, in particular in connection with multi-color printing with empty spaces between neighboring imprinting locations. As long as this effect remains almost chronologically constant at each imprinting location, this elongation can be compensated, at least partially, for example by changing the register at the cylinders, by changing the position of register rollers, or other devices.

However, the elongation behavior of the paper web is subject to many influences such as, for example, the tension/elongation characteristics of the respective paper, and thus to the prevailing tension, the instantaneous moisture, the sensitivity to moisture, the penetrating behavior, the position of the roll as it is produced in the reel spool which, for example, has the effect of differing winding hardness, or a positionally-dependent fluctuation of the module of elasticity.

Therefore the elongation, both the longitudinal and the transverse elongation, is not steady because of the inconstant paper properties of the unwinding paper web itself, and because of changing, and partially fluctuating operating parameters of the printing press. On the other hand, a fluctuating web tension, changing printing speeds, fluctuations in dampening, or a change of the roll affect the elongation of the paper web, so that the elongation is not chronologically steady.

With the aid of the method of the invention it is possible in an advantageous manner to compensate changes or fluctuations in the elongation, in particular longitudinal elongation in the conveying direction.

The determination of the change in elongation at the end of a printing tower or following the last print unit in the conveying direction is also advantageous, since it provides good information regarding the entire change for the subsequent processing steps, and allows counter-measures, if desired in the sense of a constant tension or, as preferred here, a constant elongation of the web, for the subsequent travel of the web or the processing steps. In this sense it is also advantageous that the regulation takes place not in the area of measurement, but at the start of the web, by means of which a level of the web tension, or a resulting initial elongation, is fixed and regulated thereafter without causing substantial changes of the web tension and/or elongation in the superstructure, in particular upstream of the hopper draw-in roller.

In particular, by detecting the elongation change downstream of the last print unit and by a corresponding regulation of the inlet elongation, it is possible to assure that the number and the exact phases of the print images between the last print unit, or the last imprinting location, and a folding apparatus, for example, is constant, something which is cumbersome or difficult to do by adjusting individual registers. Therefore the method makes the constant readjustment of the cutting register of a web by means of all drive mechanisms of the print units, or by means of register rollers, during the production run at least partially superfluous.

An exemplary embodiment of the invention is represented in the drawings and will be described in greater detail in what follows.

Shown are in:

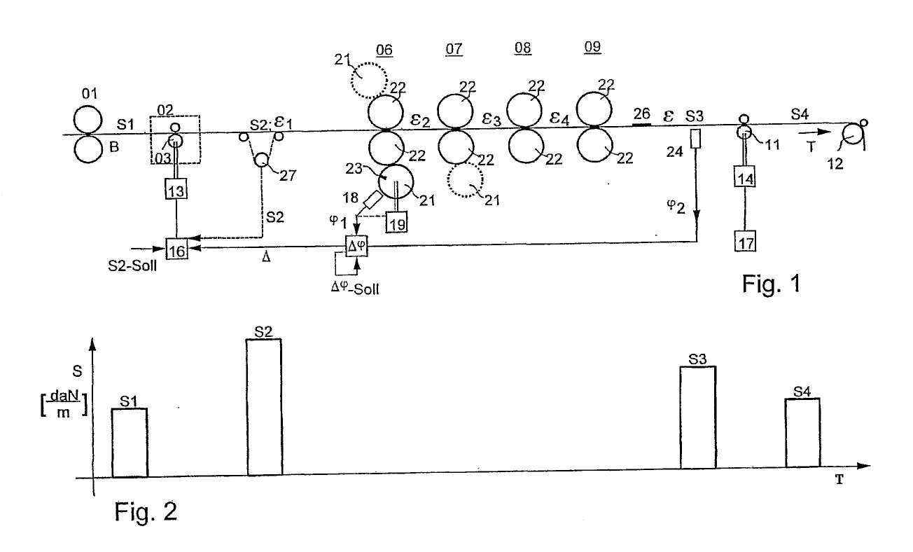

FIG. 1, a schematic representation of the guidance of a web from the draw-in unit over four print units and a second traction roller up to the hopper inlet roller,

FIG. 2, a schematic representation of the web tension level during the production run.

The course of a web B, for example a web B to be imprinted, or a paper web B, through a printing press, in particular a web-fed rotary printing press, is represented in FIG. 1. The web B runs in the conveying direction T from the roll changer 01 through a draw-in unit 02 with a traction roller 03 through the, for example four, print units 06 to 09 to a second traction roller 11. Turning bars, cutting blades, further traction or guide rollers, not represented, and finally a hopper inlet roller 12 follow downstream of the second traction roller 11, for example. In an advantageous embodiment the essential traction rollers 03, 11 are each equipped with their own drive mechanisms 13, 14, and a drive regulating device 16, 17. In a preferred embodiment, tensions S1, S2, S3 and S4 of the web B are measured upstream of the draw-in unit 02, between the draw-in unit 02 and the first print unit 06, as well as between the last print unit 09 and the traction roller 11, and on the free path between the traction roller 11 and the hopper inlet roller 12. This can take place, for example, via measuring rollers, or via the power consumption of the drive motors of the traction members.

The absolute and relative tensions S4 of the individual webs B in respect to each other at the hopper inlet roller 12 are the starting point for setting the tension in a web B, in particular when during multi-web operations several webs B are combined at the hopper inlet by means of the hopper inlet roller 12. Therefore the setting of the tensions in the web B is made starting with the desired level of the tension S4 at the hopper inlet roller 12. The level of the entire tension in the web B is preferably set by an adjustment at the draw-in unit 02. In a customary way a change of the tension in the web B also occurs in an advantageous manner during the production run by a change of the tension S2 at the draw-in unit 02. As schematically represented in FIG. 2, for example, the basic setting of the tensions during the production run is set via the traction roller 03, which is regulated in accordance with web tension, speed or position, the also regulated hopper draw-in roller 12 and/or compensating rollers, not represented.

Because of the tension and, in particular during the production run because of the moisture, the web B is subjected to longitudinal elongations on its travel from the draw-in unit 02 to the traction roller 11 downstream of the last print unit 09, with an initial elongation ε1 of the web B and an elongation ε downstream of the last print unit 09. With the web B2 passing through four print units 06 to 09, ε2 represents an elongation between the first print unit 06 and the second print unit 07, ε3 an elongation between the second print unit 07 and the third print unit 08, and ε4 an elongation between the print unit 08 and print unit 09.

This state of the web B, wherein as a rule the tension is regulated during the production run, i.e. at the printing speed and by adding water and/or ink, and where the traction roller 03 trails and the traction roller 11 leads in respect to the speed of the press, already takes into consideration an elongation of the web B which is a result of the printing process and the effects of the moisture.

The determination of the speed of the press and/or phase position of the press at the print units 06, 07, 08, 09 can take place in different ways. For example, in case each one of the print units 06, 07, 08, 09 is individually driven, it is possible to use the output data, the angle of rotation positions, or other characteristic values of all or of individual print units 06, 07, 08, 09.

In the exemplary embodiment, a phase position φ1 of the first print unit 06 is measured by means of a sensor 18. This phase position φ1 can be picked up, for example at a motor shaft of a drive mechanism 19 for the cylinder 21; in particular a drive mechanism 19 of a forme cylinder 21 of the print unit 06, for example by means of an encoder (represented in dashed lines in FIG. 1). If the forme cylinder 21 is coupled with a cooperating cylinder 22, in particular a transfer cylinder 22, the phase position φ1 of the transfer cylinder 22 can also be determined. As represented in FIG. 1, it is also possible to use the arrangement of a marker 23 as reference spot 23 at the forme cylinder 21, or on the transfer cylinder 22, together with a first sensor 18 for determining a phase position φ1, or a position l. This can be done by means of a scanner or a photoelectric cell, for example. Also, a marker 23 applied by the print unit 06 itself, a portion of the print image itself, a perforation or other markings on the web B can be used as marker 23 for determining the first phase position φ1.

A further sensor 24 is arranged downstream of the last print unit in the conveying direction T, in this case the fourth print unit 09. A second phase position φ2, or position φ2 of a marker 26, or at at least a portion of a print image of an imprinted web B, is measured. The marker 26 can also be a perforation in the web B, or an equivalently functioning marker on the web B. The phase position φ2 of the marker 26 is here understood to be the chronological sequence of the passage of the mark 26 past the detector. If the determination of the phase position φ1 is performed by means of a marker 23 arranged on the web B (as mentioned alternatively), it is possible to employ the marker 23 as the marker 26, which are identical in this case, for the determination of the phase position φ2.

During the running of the web B, first the phase position φ1 of the print unit 06 is determined by measuring the passage of the marker 23. After passing through the print units 06 to 09, the second phase position φ2 of the marker 26 printed on the web, or on the portion of the print image, is determined downstream of the last print unit 09. Assuming a fixed position of the measurement location in respect to each other, a fixed phase shift Δφ could now be determined with a chronologically constant elongation ε of the web B over all partial sections. The method for regulating a web tension in a rotary printing press comes into play here since, for the above mentioned reasons, the elongation ε of the web B is not chronologically constant during production.

The value of the phase shift Δφ, determined for example at the start of the production run and after reaching the desired tensions S1 to S4, is maintained as the reference variable Δφ-Soll in a memory unit, for example. The reference variable Δφ-Soll can be different from one production to another production, since it is a function of the register state of the print units 06 to 09. However, it should first be fixed during stationary and interference-free operation. Setting the register state, as well as the tensions S1 to S4 has, as already mentioned above, taken place in their base position, as a rule already prior to starting production, and is tailored to the paper properties, the web travel and other, above mentioned parameters.

A deviation Δ of the actual value Δφ from the reference variable Δφ-Soll now provides information regarding changes Δε or fluctuations in the elongation ε occurring in the course of the production run.

Now, in order to counteract changes Δε or fluctuations in the elongation ε, in particular changes Δε in the section length between the last print unit and further processing by folding, occurring during the production run for the above mentioned reasons, the phase positions φ1 and φ2, and therefore the phase shift Δφ, are determined and compared with the reference variable Δφ-Soll. If in the course of the production run the deviation Δ in the difference Δφ from the reference variable Δφ-Soll occurs for one of the above mentioned reasons, this is an indication for a change Δε of the elongation ε of the web B.

If the phase shift Δφ has been defined as the difference Δφ=φ2−φ1, for example, an increase in the elongation ε by Δε causes a deviation Δ of the phase shift Δφ from the reference variable Δφ-Soll, for example.

This deviation Δ, and therefore also the change Δε in the elongation ε, is now compensated with the draw-in unit 02 connected upstream of the first print unit 06 by means of the change of the initial elongation ε1, until the reference variable Δφ-Soll of the phase shift Δφ has been restored. So that an oscillation, or an erratic web running of the web B is reduced or avoided, the regulation can also allow certain tolerances in the deviation of the phase shift Δφ from the reference variable Δφ-Soll before the counter-measure of a change in the initial elongation ε1 is taken.

The deviation Δ from the reference variable Δφ-Soll can, for example, be superimposed on the reference variable transducer of the drive regulating device 16, for example as an interference variable Δ. The drive regulating device 16 of the traction roller 03 can be regulated in respect to the torque, for example, wherein a feedback of the tension S2 takes place. A path of the web B over an appropriate measuring roller 27 for measuring the tension S2 of the web B is represented in dashed lines in FIG. 1. An interference variable Δ corresponding to the deviation Δ from the reference variable Δφ-Soll is superimposed on the reference value transducer of the drive regulating device 16, for example as a correcting value ΔS2. Such a correcting value ΔS2 can be taken from a stored curve of the dependency of ΔS2 over Δ, for example, or can also be performed iteratively by raising or lowering the tension S2 until the phase shift Δφ corresponds again to the reference variable Δφ-Soll.

If it is intended to avoid abrupt changes in the effects of force on the web B, it is also possible to fall back to a drive control device with DROOP behavior for the traction roller 03. A load-dependent change of the reference variable of a circumferential or angular velocity or of the number of revolutions is called DROOP behavior, which takes into consideration a change in the tension of the web B, for example S4, as well as a change in the angular velocity. In this case, too, a correcting value ΔS2 is superimposed on the reference variable S2-Soll for the tension S2 which, together with the actual value of the tension S2 by means of the DROOP function results in a corresponding trailing of the traction roller 03, and therefore a different tension S2 and resultant initial elongation ε1, which in the end also appears as a change of the elongation ε.

Regardless of the type of regulation of the traction roller 03, or the draw-in unit 02, it is essential that an interference variable Δ, derived from the phase shift Δφ and the reference variable Δφ-Soll, is superimposed on the reference variable Δφ-Soll for the drive regulating device 16, for example as the correction value ΔS2 of the desired tension S2. If required, it is possible to determine the phase position φ1 on one of the subsequent print units 07 to 09 instead of at the print unit 06, the first in the conveying direction T. In this case the phase shift Δφ must be determined between the respective print units 06 to 09 and the passage of the marker 23 at the sensor 24. The deviation Δ of the phase shift Δφ from the reference variable Δφ-Soll is again processed as the interference variable Δ for the drive mechanism of the traction roller 03.

Synonymous with the determination of the phase positions φ1 and φ2, and therefore of the phase shift Δφ from the reference variable Δφ-Soll for establishing the interference variable Δ, it is also possible to use the chronological change of the phase shift Δφ or, if the interference variable Δ is determined linearly from the difference in the phase position φ1 and φ2, also to use the change in the difference in the chronological change of the phase positions Δφ=φ2−φ1. In that case, Δφ≈0 in the interference-free operation.

The correction value ΔS2 as the tension change ΔS2 can also be changed in other ways at the traction roller 03 by means of the interference variable Δ. The change of the tension S2 by means of the interference variable Δ also includes changes in the force effect from a compensating roller, not represented, or other actuating devices for the tension S2 arranged upstream of the first print unit 06.

In an advantageous manner no direct feedback of an elongation change Δε detected downstream of the last print unit 09 to the drive regulating device 17 of the traction roller 11 arranged downstream of the last print unit 09 takes place, instead a change of the initial elongation ε1 takes place by means of a change of the tension S2.

Thus, with a change Δε of the elongation ε, a deviation Δ of the relative phase position Δφ from the reference variable Δφ-Soll between a first measurement location by means of the sensor 18, of the phase position ε1 of the transfer cylinder 21, and the second measuring location by means of the sensor 24, the position of the mark 23 on the imprinted web B after passage through the print units 06 to 09, occurs. This deviation Δ is entered as an absolute value, or as a signed value, as the interference variable Δ for regulating the tension S2 upstream of the first print unit 06. By means of this method it is assured that for subsequent work steps, such as folding or cutting, for example, there is a constant number of print images between the traction roller 11 and the following processing step, and that the frequency of the passage of the print images at the traction roller 11 is maintained almost constant.

Thus, a variation in the tension S2 upstream of the first print unit 06 is tolerated, if necessary, in favor of a constant section length, or elongation ε, downstream of the last print unit 09. However, in any case the tension S2 moves within a window of the permissible tension and of the resultant tension S4 in view of the gradation during multi-web operations.

List of Reference Symbols

01 Roll changer

02 Draw-in unit

03 Traction roller

04 -

05 -

06 Print unit, first

07 Print unit, second

08 Print unit, third

09 Print unit, fourth

10 -

11 Traction roller

12 Hopper inlet roller

13 Drive mechanism

14 Drive mechanism

15 -

16 Drive regulating device

17 Drive regulating device

18 Sensor, first

19 Drive mechanism

20 -

21 Cylinder, forme cylinder

22 Cylinder, transfer cylinder

23 Marker, reference spot (21)

24 Sensor, second

25 -

26 Marker, part of the print image

27 Measuring roller

φ1 Phase position, position

φ2 Phase position, position

Δφ Phase shift

Δφ-Soll Reference variable

Δφ Chronological change of the phase shift

Δφ Change of the difference in the chronological change of the phase shifts

φ1 Chronological change of the phase position

φ2 Chronological change of the phase position

Δ Deviation, interference variable

ε1 Initial elongation

ε2 Elongation (06, 07)

ε3 Elongation (07, 08)

ε4 Elongation (08, 09)

Δ Elongation

Δε Change of the elongation (ε)

S1 Tension

S2 Tension

S3 Tension

S4 Tension

ΔS2 Correction values

S2-Soll Reference variable

B Web, web to be imprinted, paper web

T Conveying direction

1. A method for regulating a web tension in a rotary printing press, wherein a web (B) passes through at least one print unit (06, 07, 08, 09), and a first phase position (φ1) of the at least one print unit (06, 07, 08, 09) is measured, and a second phase position (φ2) of a marker (26) located on the web (B) is measured downstream of the print unit (06, 07, 08, 09), viewed in the conveying direction (T), characterized in that as a result of a deviation (Δ) of an actual value of a phase shift (Δφ) from a reference variable (Δφ-Soll) an initial elongation (ε1) of the web (B) upstream of the print unit (06, 07, 08, 09) is changed by means of a regulation of the tension (S2).

2. The method in accordance with claim 1, characterized in that the web (B) passes through at least two print units (06, 07, 08, 09) and the second phase position (φ2) is determined downstream of the last print unit (09) in the conveying direction (T).

3. A method for regulating a web tension in a rotary printing press, wherein a web (B) passes through at least two print units (06, 07, 08, 09), and a first phase position (φ1) of the one of the print units (06, 07, 08, 09) is measured, and a second phase position (φ2) is measured downstream of one of the print units (06, 07, 08, 09), viewed in the conveying direction (T), and wherein as a function of these phase positions (φ1, φ2) a tension (S2) of the web (B) upstream of the first of the print units (06, 07, 08, 09) is changed, characterized in that the second phase position (φ2) is determined downstream of the last print unit (09) in the conveying direction (T).

4. The method in accordance with claim 3, characterized in that the second phase position (φ2) is determined at a marker (26) located on the web (2).

5. The method in accordance with claim 3, characterized in that for changing the initial elongation (ε1) the tension (S2) is changed.

6. The method in accordance with claim 3, characterized in that the tension (S2) is changed as the result of a deviation (Δ) of an actual value of a phase shift (Δφ) from a reference variable (Δφ-Soll).

7. The method in accordance with claim 2 or claims 4 to 6, characterized in that
a first sensor (18) detects the phase position (φ1) of the print unit (06, 07, 08, 09) at a cylinder (21, 22),
a second sensor (24), arranged downstream of the last print unit (09) in the conveying direction (T), detects the second phase position (φ2) of the marker (26) imprinted on the web (B),
the actual value of the phase shift (Δφ) is determined by means of the two phase positions (φ1, φ2),
the reference variable (Δφ-Soll) is fixed in the stationary and interference-free operation, and
in case of a falling below or exceeding of a tolerance to be determined of the reference variable (Δφ-Soll) because of the phase shift (Δφ), the change in the tension (S2) of the web (B), and therefore of the initial elongation (ε1) of the web (B) upstream of the first print unit (06) takes place.

8. The method in accordance with claim 1 or 2, characterized in that the change of the tension (S2) takes place in such a way that the phase shift (Δφ) is fed back to the reference variable (Δφ-Soll).

9. The method in accordance with claim 2 or 3, characterized in that the regulation of the tension (S2) takes place with the stipulation that a number of print images on the web (B) is kept constant between the last print unit (09) and a subsequent processing stage.

10. The method in accordance with claim 1 or 6, characterized in that in the course of the production run the actual value of the phase shift (Δφ) is compared with the reference variable (Δφ-Soll), and that the deviation (Δ) of the phase shift (Δφ) from the reference variable (Δφ-Soll) is used as the interference variable (Δ) for regulating a draw-in unit (02).

11. The method in accordance with claim 7, characterized in that the first phase position (φ1) at the cylinder (21, 22) is determined by the first sensor (18) by means of a reference spot (23) arranged on the cylinder (21, 22).

12. The method in accordance with claim 7, characterized in that the cylinder (21) is a forme cylinder (21).

13. The method in accordance with claim 2 or 3, characterized in that the first phase position (φ1) is determined at the first print unit (06) in the conveying direction (T).

14. The method in accordance with claim 1 or 4, characterized in that at least a portion of the print image (26) is employed as the marker (26) for determining the second phase position (φ2).

15. The method in accordance with claim 2 or 3, characterized in that the interference variable (Δ) is fed back to a drive regulating device (16) of a traction roller (03), which is located upstream of the first print unit (06).

16. The method in accordance with claim 10, characterized in that the interference variable (Δ) is fed back as a correction value (ΔS2) to a reference variable (Δφ-Soll) for the tension (S2) between the draw-in unit (02) and the first print unit (06).
